(19) United States
(12) Patent Application Publication
(10) Pub. No.: US 2013/0226738 A1
(43) Pub. Date: Aug. 29, 2013

(54) SYSTEM AND METHOD FOR FLIPPING OF PURCHASE ORDER INTO INVOICE

(71) Applicants: SACHIN SHARMA, MUMBAI (IN); PRASAD GUPTE, MUMBAI (IN)

(72) Inventors: SACHIN SHARMA, MUMBAI (IN); PRASAD GUPTE, MUMBAI (IN)

(21) Appl. No.: 13/559,815

(22) Filed: Jul. 27, 2012

(30) Foreign Application Priority Data
Feb. 24, 2012 (IN) 510/MUM/2012

(51) Int. Cl. G06Q 30/04

(52) U.S. Cl. 705/26.81

(57) ABSTRACT

A system is described for flipping of purchase orders into invoices within an e-procurement software tool. When a purchase order is sent to a supplier network/portal system, information of the items is retrieved from the purchase order, which is stored on a computer readable storage medium of the supplier network/portal system, followed by comparing the item inputs or pre-determined fields on the invoice with purchase orders to obtain a first compared output, followed by comparing the first compared output with a tolerance limit to obtain a second compared output, followed by copying and flipping the information into the invoice.

### CROSS-REFERENCE TO RELATED APPLICATION

The instant application claims priority to Indian Patent Application Ser. No. 510/MUM/2012, filed Feb. 24, 2012, pending, the entire specification of which is expressly incorporated herein by reference.

### FIELD OF THE INVENTION

The present invention relates to the field of e-commerce and electronic procurement. In particular, the invention relates to a system and method of flipping of purchase orders into invoices.

### BACKGROUND OF THE INVENTION

In the e-procurement process, the user/buyer selects items, i.e. goods or services, from the catalog of suppliers and sends purchase orders to the supplier. Once the purchase order is received, an invoice is generated and sent to the user/buyer.

Historically, invoices are generated by the supplier, e.g., by entering the information of the items that are to be purchased by the user/buyer to the supplier. A disadvantage is that the supplier has to take duplicate data entry efforts because item information is already available in the purchase order.

Though there are some systems that implement creation of an invoice from image scanning of invoices, as well as some portals which do exchange purchase orders and invoices between the user/buyer and supplier/vendor, none of the systems are adapted for copying items information from the purchase orders into invoices.

### SUMMARY OF THE INVENTION

The present invention provides a system operable for flipping/copying the items information from purchase orders into invoices, thereby reducing the duplicate data entry efforts and thus saving time.

The present invention also provides a choice to the user/buyer to modify the fields which are variable, e.g., if the unit price has changed, the user may modify the number of items that are to be purchased.

The present invention is also operable to implement 2-way or 3-way matching of invoices.

An object of the invention is to provide a system for flipping of purchase orders into invoices.

Another object of the present invention is to provide a system that automatically retrieves item information from purchase orders without the user having to re-enter same while creating invoices.

Yet another object of the invention is to provide a system that facilitates the user to change the item information and modify the fields in the purchase order.

Still another object of the present invention is to provide a system for facilitating an automatic match of the purchase order with the submitted invoice(s).

By way of a non-limiting example, the present invention introduces a system for flipping of purchase orders into invoices within an e-procurement software tool. In the present invention, when a purchase order is sent to a supplier network/portal system, information of the items is retrieved from the purchase order, which is stored on a computer readable storage medium of the supplier network portal system, followed by comparing the item inputs or pre-determined fields on the invoice with the purchase orders to obtain a first compared output, followed by comparing the first compared output with a tolerance limit to obtain a second compared output, followed by copying and flipping the information into the invoice.

In the present invention, the system may create the invoice by automatically matching the purchase order with the invoices. Thus, the invoices are created by automatically retrieving information from the purchase order without having to re-enter same. The system may also be operable for flipping of purchase orders into multiple invoices.

In accordance with one illustrative embodiment of the present invention, a system is provided for flipping purchase orders in relation to a procurement system into an invoice in a verifiable manner, comprising: (1) a processor unit; and (2) a computer readable medium storing instructions executable by the processor unit comprising: (a) a receiving system to receive a filled purchase order form including pre-defined fields relating to requested goods from a supplier; (b) a retrieval system to retrieve the information of items from the purchase order requested by the user; (c) a storing system to store the retrieved information of items on the computer readable storage medium of the supplier network portal system; (d) a first comparing system adapted to compare item inputs or pre-determined fields on the invoice with the purchase orders to obtain a first compared output; (e) a second comparing system adapted to compare the first compared output with tolerance limits to obtain a second compared output; and (f) an invoice flipping system adapted to copy/flip information from the purchase order form to an invoice generating means or system adapted to generate an invoice in respect of items supplied by the supplier.

In accordance with another illustrative embodiment of the present invention, a method is provided for flipping a purchase order into an invoice, comprising: (1) providing a retrieval system to retrieve the information of items from the purchase order requested by the user; (2) providing a storing system to store the retrieved information of items on a computer readable storage medium of the supplier network/portal system; (3) providing a first comparing system to compare the items those will be sent by the supplier and items those are ordered by the user to obtain a first compared output; (4) providing a second comparing system to compare the first compared output with tolerance limits to obtain a second compared output; and (5) providing an invoice flipping system to copy/flip information from the purchase order form to an invoice generating system adapted to generate an invoice in respect of items supplied by the supplier.

### BRIEF DESCRIPTION OF THE DRAWINGS

The invention will now be described in relation to the accompanying drawings in which:

FIG. 1 illustrates an e-procurement software tool;

FIG. 2 illustrates a schematic of a system for flipping of purchase orders into invoices;

FIG. 3 illustrates a schematic of an alternative system for flipping of purchase orders into invoices.

### DETAILED DESCRIPTION OF THE INVENTION

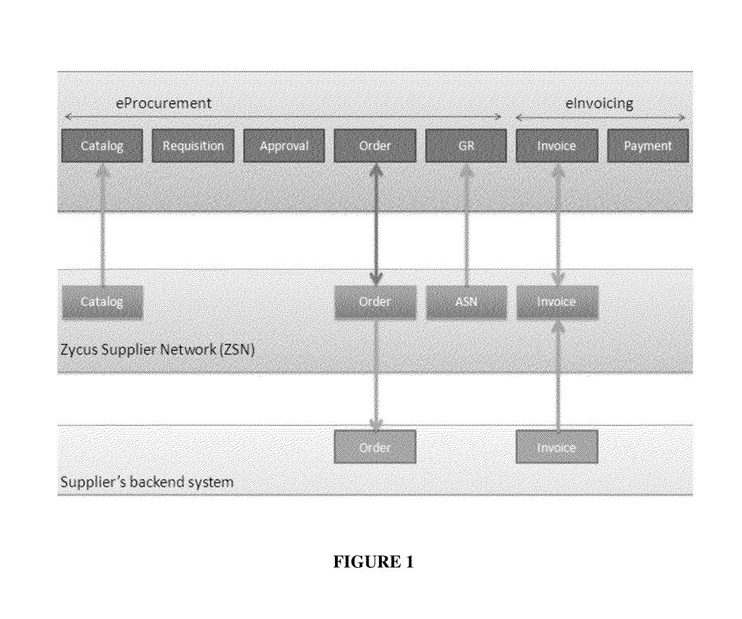

Referring to the Figures generally, there is provided a system for flipping of purchase orders into invoices within a procurement software tool. In one embodiment of the invention, a system for flipping purchase order (PO) into invoices (INV) comprises: a user front end system, a supplier network/portal system and an optional supplier back end system (e.g., see FIG. 1).

The user front end system may comprise a procurement system and invoicing system. The procurement system may further comprise: a system for selection of goods and/or services from a catalog of suppliers of goods and services; a system for sending requisitions of purchases; a system for approving the requisitions; a system for placing purchase orders (PO) and a system for generating goods receipts. The invoicing system may comprise: a system for creating invoices (INV) and system for making payments. The procurement system may be adapted for ordering goods and/or services from supplier's while an invoicing system may be adapted for creating invoices (INV) by flipping items information from purchase orders (PO) into invoices (INV) and for making payments.

In the present invention, the system may be operable for creation of invoices in 3 ways:

(1) E-invoice—it may be created in a standard format such as cXML or EDI from the supplier network/portal to the user;

(2) Manually created e-invoice—by logging onto the supplier network/portal system, the supplier may copy the information on purchase orders into invoices; and

(3) Manual/paper invoice—paper invoices which are received by accounts payable (AP) may be manually entered.

In the present procurement system, purchase orders may be sent by the user to the supplier network/portal, and after confirmation of the requested goods and/or services, a copy of the purchase order (PO) may be sent to the supplier back end system and another copy along with goods receipt (GR) sent back to the user. While sending this other copy of the purchase order (PO) to the user, an invoice may be created by the supplier network/portal. Such an invoice may be created by automatically retrieving the items information from the purchase order (PO) and copying it into the invoice. Thus, the user does not have to re-enter the information, which saves time and duplicate data entry efforts of the user.

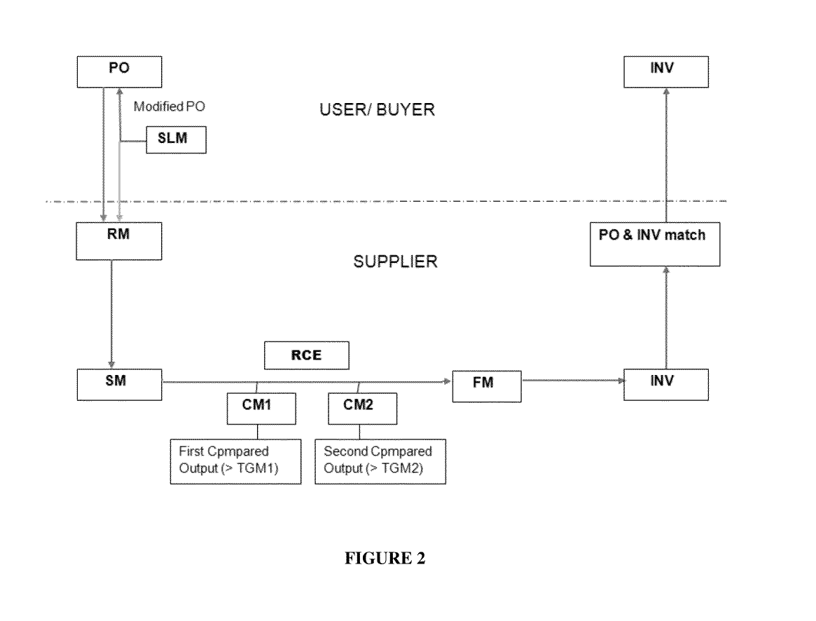

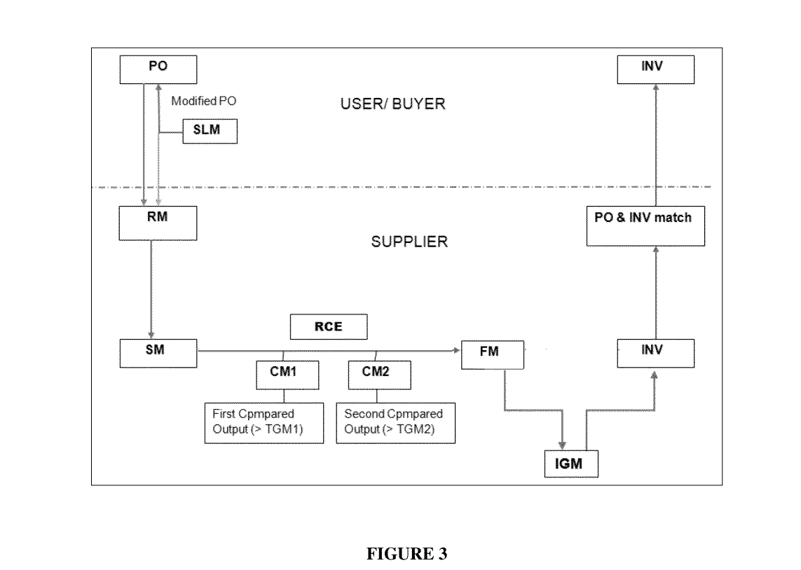

Referring to FIGS. 2 and 3, there are shown two illustrative systems for flipping of purchase orders into invoices.

In one embodiment of the present invention, when the purchase order (PO) is sent to the supplier network/portal system, receiving means or system may receive a filled purchase order form, including pre-defined fields relating to requested goods from a supplier, and retrieval means or system (RM) may retrieve the items information from the purchase order (PO).

Selection means or system (SLM) may give the user the choice to make changes in the purchase order (PO) or to select one or more items that are to be invoiced, and modified purchase orders may then be re-sent to the supplier network/portal system.

In another embodiment, storing means or system (SM) may temporarily store the retrieval information of items on the supplier network portal system.

In still another embodiment, invoice flipping means or system (FM) may be provided to copy/flip information from the purchase order form to an invoice generating means or system (IGM) adapted to generate an invoice in respect of items supplied by the supplier (e.g., see FIG. 3).

In yet another embodiment of the present invention, first comparing means or system (CM1) may compare the items that may be sent by the supplier and items that are ordered by the user through a purchase order (PO) to obtain a first compared output.

When the invoice is created, a second comparing means or system (CM2) may compare the items that may be sent by the supplier and items for which the invoice (INV) may be created to obtain a second compared output.

In one embodiment, there is provided a first tolerance limit generating means or system (TGM1) adapted to generate tolerance values for the first comparing means or system (CM1).

Breach of tolerance values may generate corresponding outputs at the first comparing means or system (CM1).

In another embodiment, there may be provided a second tolerance limit generating means or system (TGM2) adapted to generate tolerance values for the second comparing means or system (CM2).

Breach of tolerance values may generate corresponding outputs at the second comparing means or system (CM2).

In still another embodiment, there may be provided a rule creation engine (RCE) adapted to create rules in relation to each of the first compared output and the second compared output. These rules may be decision rules.

When matching invoices, the system may consider the sent items. Because there may be a one-to-one correlation between the purchase order (PO) and the invoice line items, the system may compare the ordered items with the invoice being created (e.g., thus facilitating 3-way invoice matching process).

According to the present invention, the purchase order (PO) may also be flipped into multiple invoices.

What is claimed is:

1. A system for flipping purchase orders in relation to a procurement system into an invoice in a verifiable manner, comprising:
a processor unit; and
a computer readable medium storing instructions executable by the processor unit comprising:
a receiving system to receive a filled purchase order form including pre-defined fields relating to requested goods from a supplier;
a retrieval system to retrieve the information of items from the purchase order requested by the user;
a storing system to store the retrieved information of items on the computer readable storage medium of the supplier network portal system;
a first comparing system adapted to compare item inputs or pre-determined fields on the invoice with the purchase orders to obtain a first compared output;
a second comparing system adapted to compare the first compared output with tolerance limits to obtain a second compared output; and
an invoice flipping system adapted to copy/flip information from the purchase order form to an invoice generating system adapted to generate an invoice in respect of items supplied by the supplier.

2. The system as claimed in claim 1, further comprising a selection system for facilitating the user to select items from the purchase order that are to be invoiced.

3. The system as claimed in claim 1, further comprising a rule creation engine adapted to create rules in relation to each of the first compared output and second compared output.

4. The system as claimed in claim 1, wherein the system compares ordered items from the user with the invoice being created by the supplier.

5. The system as claimed in claim 1, wherein the system for creation of the invoice against the purchase order is adapted for automatic retrieval of items information of purchase order by the supplier network/portal system, thus flipping purchase orders into invoices.

6. The system as claimed in claim 1, wherein further comprising a tolerance limit generating system adapted to generate tolerance values for the second comparing system.

7. The system as claimed in claim 1, wherein the system facilitates the user to modify the fields on the purchase order that are variable.

8. The system as claimed in claim 1, wherein the system is adapted for flipping of the purchase order into multiple invoices.

9. A method for flipping a purchase order into an invoice, comprising:
providing a retrieval system to retrieve the information of items from the purchase order requested by the user;
providing a storing system to store the retrieved information of items on a computer readable storage medium of the supplier network/portal system;
providing a first comparing system to compare the items those will be sent by the supplier and items those are ordered by the user to obtain a first compared output;
providing a second comparing system to compare the first compared output with tolerance limits to obtain a second compared output; and
providing an invoice flipping system to copy/flip information from the purchase order form to an invoice generating system adapted to generate an invoice in respect of items supplied by the supplier.

10. The method as claimed in claim 9, wherein the method facilitates the user to select items from the purchase orders that are to be invoiced.

11. The method as claimed in claim 9, further comprising the step of creating rules in relation to each of the first compared output and second compared output.

12. The method as claimed in claim 9, further comprising the step of generating tolerance values for the second comparator.

13. The method as claimed in claim 9, wherein the method facilitates the user to modify the fields on the purchase order that are variable.

14. The method as claimed in claim 9, wherein the method is adapted for flipping of the purchase order into multiple invoices.
